(19) United States
(12) Patent Application Publication
(10) Pub. No.: US 2020/0200264 A1
(43) Pub. Date: Jun. 25, 2020

(54) SPLIT OIL CIRCUIT

(71) Applicant: GM Global Technology Operations LLC, Detroit, MI (US)

(72) Inventors: Salvatore Mafrici, Torino (IT); Michele Bilancia, Torino (IT); Giorgio Candela, Turin (IT); Francesco Barba, Sorrento (IT)

(21) Appl. No.: 16/225,280

(22) Filed: Dec. 19, 2018

(51) Int. Cl. F16H 61/00; F16H 57/04

(52) U.S. Cl. CPC F16H 61/0025; F16H 2061/0096; F16H 2061/0037; F16H 57/0446

(57) ABSTRACT

A system for controlling oil pressure and flow includes an oil pump generating pressurized oil for an engine. Multiple oil system segments each have a feed line. A signal generating control device is in communication with at least one flow control member. The signal generating control device identifies one of multiple operating points of a vehicle engine, selects a pressure and a flow rate of the pressurized oil for the feed line of each of the oil system segments optimizing the pressure and the flow rate of the pressurized oil at the identified one of the operating points, and adjusts a position of the at least one flow control member to deliver the optimized pressure and the flow rate of the pressurized oil. A control system in communication with the signal generating control device directs operation of the flow control member and collects data defining engine working conditions.

### INTRODUCTION

The present disclosure relates to oil control and distribution systems for automobile vehicle engines.

Oil distribution circuits for automobile vehicle engines control oil pressure by regulating pressure at a calibrated value for the entire circuit. The regulating pressure is defined based on component requirements of the system. At each engine operating point, the component that requires the highest oil pressure level or flow rate drives or determines the calibration value for all components and branches of the oil system at that operating point. The other branches and components therefore receive a higher flow rate and a higher oil pressure than required. This method of operation requires the oil pump to provide a higher net operating flow rate than required to satisfy the individual component requirements and may lead to unnecessary pump wear.

Thus, while current vehicle oil distribution systems achieve their intended purpose, there is a need for a new and improved system and method for control oil flow and pressure to the individual system components.

### SUMMARY

According to several aspects, a system for controlling oil pressure and flow in an automobile vehicle oil system includes an oil pump generating pressurized oil. Multiple oil system segments each have a feed line. At least one flow control member is in communication with the multiple oil system segments. A signal generating control device is in communication with the at least one flow control member. The signal generating control device identifies one of multiple operating points of a vehicle engine, selects a pressure and a flow rate of the pressurized oil for the feed line of each of the oil system segments optimizing the pressure and the flow rate of the pressurized oil at the identified one of the operating points, and adjusts a position of the at least one flow control member to deliver the optimized pressure and the flow rate of the pressurized oil.

In another aspect of the present disclosure, the at least one flow control member defines a rotary valve.

In another aspect of the present disclosure, the rotary valve is directly connected to the feed line of each of the oil system segments.

In another aspect of the present disclosure, the oil system segments include a turbocharger, an engine head, a bank of pistons and multiple bearings.

In another aspect of the present disclosure, the feed line for each of the components includes: a turbocharger feed line which provides oil flow to the turbocharger; a head feed line providing oil flow to the engine head; a piston feed line providing oil flow to the bank of pistons; and a bearing feed line providing oil flow to the multiple bearings.

In another aspect of the present disclosure, a signal conditioning circuit receives a rotary valve position signal and an oil pressure signal from the rotary valve. An output from the signal conditioning circuit is processed using a software circuit which identifies from data tables saved in a memory an appropriate flow rate and a target pressure required for each feed line feeding the turbocharger, the engine head, the bank of pistons and the multiple bearings for each system operating point.

In another aspect of the present disclosure, the at least one flow control member defines multiple electronically-controlled valves (ECVs) individually positioned in the feed line of each of the segments to provide individualized pressure and flow rate control for each feed line.

In another aspect of the present disclosure, the oil system segments include a turbocharger having a turbocharger feed line, an engine head having an engine head feed line, a bank of pistons having a piston feed line and multiple bearings having a bearing feed line.

In another aspect of the present disclosure, a pressure control system generates individual control signals for each of the ECVs positioned in each of the feed lines.

In another aspect of the present disclosure, the pressure control system is in communication with: a first pressure sensor providing a signal of a sensed pressure in the turbocharger feed line; a second pressure sensor providing a signal of a sensed pressure in the head feed line; a third pressure sensor providing a signal of a sensed pressure in the piston feed line; and a fourth pressure sensor providing a signal of a sensed pressure in the feed line to the bearing feed line. A first pressure and flow rate is delivered to the turbocharger, a second pressure and flow rate is delivered to the engine head, a third pressure and flow rate is delivered to the bank of pistons and a fourth pressure and flow rate is delivered to the bearings at each operating point of the system.

According to several aspects, a system for controlling oil pressure and flow in an automobile vehicle oil system includes an oil pump generating pressurized oil for an engine. Multiple oil system segments each have a feed line. A signal generating control device is in communication with at least one flow control member. The signal generating control device identifies one of multiple operating points of a vehicle engine, selects a pressure and a flow rate of the pressurized oil for the feed line of each of the oil system segments optimizing the pressure and the flow rate of the pressurized oil at the identified one of the operating points, and adjusts a position of the at least one flow control member to deliver the optimized pressure and the flow rate of the pressurized oil. A control system is in communication with the signal generating control device for directing operation of the flow control member, the control system collecting data defining engine working conditions.

In another aspect of the present disclosure, the flow control member defines a rotary valve in direct communication with each the multiple oil system segments. The control system using the engine working conditions enters different system maps saved in a memory to determine each of a turbocharger target pressure, a piston target pressure, a main gallery target pressure, and a cylinder head target pressure.

In another aspect of the present disclosure, each of the target pressures are entered into a rotary valve position optimizer. The rotary valve position optimizer identifies an optimized rotary valve position which most closely satisfies all of the turbocharger target pressure, the piston target pressure, the main gallery target pressure and the cylinder head target pressure for a given system condition.

In another aspect of the present disclosure, a rotary valve controller receives the optimized rotary valve position identified by the rotary valve position optimizer and the rotary valve controller signals position changes to the rotary valve.

In another aspect of the present disclosure, the at least one flow control member defines multiple electronically-controlled valves (ECVs) individually positioned in the feed line of each of the segments to provide individualized pressure and flow rate control for each feed line.

In another aspect of the present disclosure, a pressure sensor is positioned in each of feed lines each producing a pressure signal forwarded to a signal conditioning circuit of the control system.

In another aspect of the present disclosure, a common distribution rail receives pressurized oil from the oil pump. Each feed line of the multiple oil system segments receives oil flow from the common distribution rail.

According to several aspects, a method for controlling oil pressure and flow in an automobile vehicle oil system includes: generating pressurized oil for an engine using an oil pump; connecting an individual feed line to multiple oil system segments; providing at least one flow control member; positioning a signal generating control device in communication with the at least one flow control member. The signal generating control device: identifies one of multiple operating points of a vehicle engine; selects a pressure and a flow rate of the pressurized oil for the feed line of each of the oil system segments; and optimizes the pressure and the flow rate of the pressurized oil at the identified one of the operating points. A position of the at least one flow control member is adjusted to deliver the optimized pressure and the flow rate of the pressurized oil using a control system in communication with the signal generating control device.

In another aspect of the present disclosure, the method further includes collecting data defining engine working conditions and entering the data into the control system.

In another aspect of the present disclosure, the adjusting a position of the at least one flow control member defines rotating a rotary valve based on a signal generated by the control system and delivered to the rotary valve by the signal generating control device.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a diagram of a split oil circuit according to an exemplary embodiment;

FIG. 2 is a diagram of a split oil circuit according to another exemplary embodiment;

FIG. 3 is a diagram identifying input data for the split oil circuit of FIG. 2;

FIG. 4 is a graph comparing the split oil circuit of FIG. 2 with a conventional oil distribution circuit;

FIG. 5 is a set of lookup tables for controlling the split oil circuit of FIG. 1;

FIG. 6 is a control system diagram for the split oil circuit of FIG. 1; and

FIG. 7 is a control system diagram for the split oil circuit of FIG. 2.

### DETAILED DESCRIPTION

The following description is merely exemplary in nature and is not intended to limit the present disclosure, application, or uses.

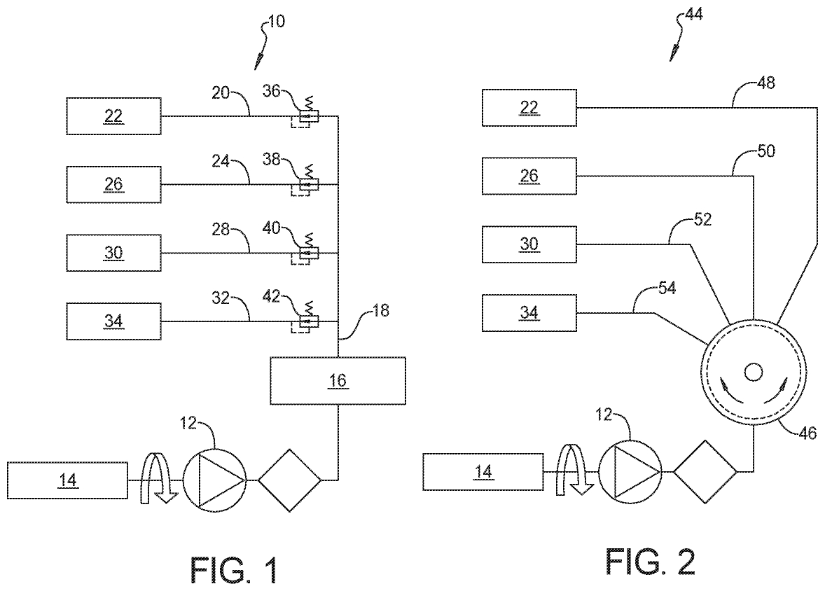

Referring to FIG. 1, according to several aspects a first split oil circuit 10 includes an oil pump 12 which is powered by rotation of a crankshaft 14 to deliver pressurized oil to a common distribution rail 16. According to several aspects, the oil pump 12 can be selected from various designs of pumps including a CVDOP, a hybrid pump, two small pumps positioned in parallel or the like. From the rail 16 a common header 18 distributes oil flow to multiple oil system segments including to each of a turbocharger feed line 20 which provides oil flow to a turbocharger 22, to a head feed line 24 which provides oil flow to an engine head 26, to a piston feed line 28 which provides oil flow to a bank of pistons 30, and to a bearing feed line 32 which provides oil flow to multiple bearings 34. Because the oil pressure and flow rate required at any operating point for each segments including each of the turbocharger 22, the engine head 26, the bank of pistons 30 and the bearings 34 can vary, the first split oil circuit 10 includes at least one flow control member which according to several aspects defines an electronically-controlled valve (ECV) positioned in each of the feed lines to provide individualized pressure and flow rate control for each feed line.

For example, a first ECV 36 is positioned in the turbocharger feed line 20, a second ECV 38 is positioned in the head feed line 24, a third ECV 40 is positioned in the piston feed line 28, and a fourth ECV 42 is positioned in the bearing feed line 32. A first pressure and flow rate can therefore be delivered to the turbocharger 22, a second pressure and flow rate can be delivered to the engine head 26, a third pressure and flow rate can be delivered to the bank of pistons 30 and a fourth pressure and flow rate can be delivered to the bearings 34 at each operating point of the system. By individual control signals provided to each of the ECVs, any one or all of the delivered pressures and flow rates can vary from the other delivered pressures and flow rates.

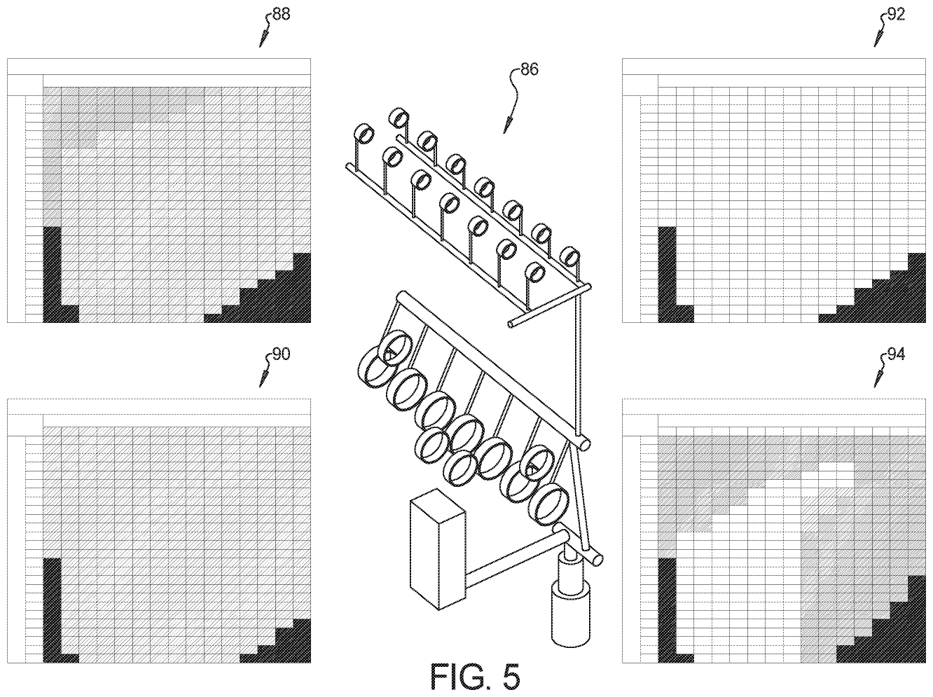

The split oil circuit 10 provides for pressure control and therefore flow control of all the oil flow feed lines 20, 24, 28, 32 independently of each other through the use of the ECVs 36, 38, 40, 42 positioned in each branch. By controlling individual branch pressure to a required pressure for each component at each system operating point described in greater detail in reference to FIG. 5 and thereby controlling individual branch oil flow rate, a total engine oil flow and pressure are reduced. Consequently, the work performed by the oil pump 12 is reduced compared to a circuit delivering only a single flow rate and pressure, and a vehicle fuel consumption is also reduced.

Referring to FIG. 2 and again to FIG. 1, according to several aspects a second split oil circuit 44 is modified from the first split oil circuit 10, therefore certain components are common. The second spit oil circuit includes the oil pump 12 which is powered by rotation of the crankshaft 14. The rail 16 is omitted in this aspect the second split oil circuit 44 includes at least one flow control member which according to several aspects defines a rotary valve 46 which allows further simplification compared to the first split oil circuit 10 by elimination of the ECVs. By selective rotation of the rotary valve 46 to predetermined positions based on the system engine operating points the second split oil circuit 44 delivers pressurized oil directly from the rotary valve 46 at different flow rates and at different pressures to individual feed lines each in communication with one of the turbocharger 22, the engine head 26, the bank of pistons 30 and the bearings 34 with the dedicated feed lines each directly connected to the rotary valve 46. The rotary valve 46 is directly connected to a turbocharger feed line 48 which provides oil flow to the turbocharger 22, to a head feed line 50 providing oil flow to the engine head 26, to a piston feed line 52 providing oil flow to the bank of pistons 30, and to a bearing feed line 54 providing oil flow to the multiple bearings 34.

By optimizing branch pressures using predetermined positions of the rotary valve 46 to provide oil pressure within a required pressure range for each system operating point described in greater detail in reference to FIG. 5 and thereby optimizing branch oil flow rates, a total engine oil flow and pressure are reduced compared to common oil circuits delivering only a single flow rate and pressure. Consequently, the work performed by the oil pump 12 is reduced and a vehicle fuel consumption is also reduced.

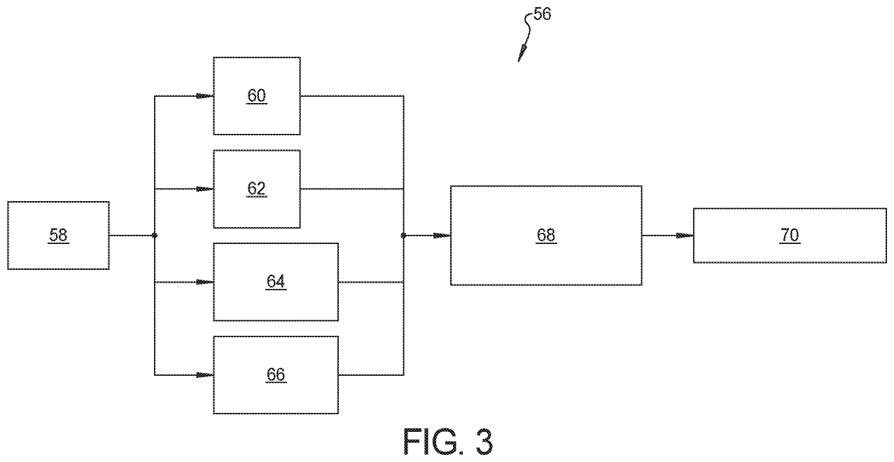

Referring to FIG. 3 and again to FIG. 2, a control system 56 for directing operation of the rotary valve 46 collects data defining engine working conditions 58. From the engine working conditions, by entering different system maps saved in a memory as shown and described in greater detail in reference to FIG. 5, a turbocharger target pressure 60 is determined. Similarly, a piston target pressure 62, a main gallery target pressure 64 and a cylinder head target pressure 66 are determined. Each of the target pressures are entered into a rotary valve position optimizer 68. The rotary valve position optimizer 68 satisfies the different pressure requests by identifying an optimized position of the rotary valve 46 which most closely satisfies all of the target pressure requests of the turbocharger target pressure 60, the piston target pressure 62, the main gallery target pressure 64 and the cylinder head target pressure 66 for a given system condition. The optimized rotary valve position identified by the rotary valve position optimizer 68 is forwarded to a rotary valve low level controller or pulse width modulated (PWM) driver 70 which signals any position change to the rotary valve 46.

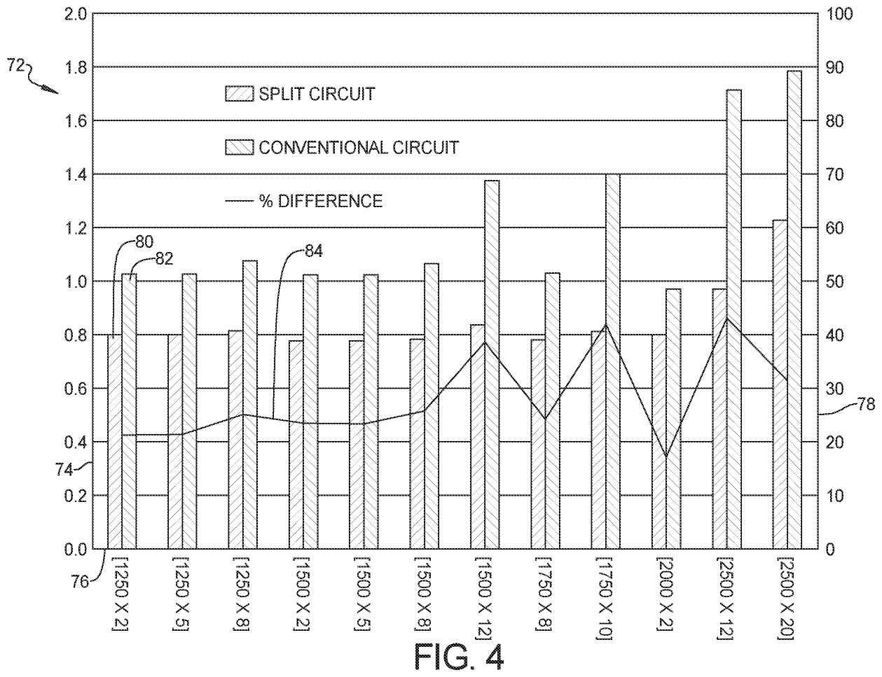

Referring to FIG. 4 and again to FIGS. 2 and 3, a graph 72 provides a comparison of a pump torque 74 (Nm) at various outputs 76 and a percentage difference 78 for multiple points such as at a point 80 defining the split circuit 10 of the present disclosure having the capability to independently control each branch compared to comparable points such as a point 82 for a conventional oil distribution system having parallel flow paths that lacks the capability to independently control pressure and flow rate in each system branch. A curve 84 defines the percentage differences at each operating point between the split circuit 10 of the present disclosure and a conventional oil distribution system. The split circuit 10 of the present disclosure is shown to provide improvements ranging between approximately 20% to 40% compared to the conventional oil distribution system.

Referring to FIG. 5 and again to FIGS. 1 through 4, an oil distribution system 86 includes the split circuit 10 of the present disclosure. The oil distribution system 86 provides multiple maps defining look-up tables of data related to different engine operating points. These maps include a first map 88 defining brake mean effective pressure (BMEP) ranges (bar) versus engine speed (rpm) identifying oil pressures required at the cylinder head over the various engine operating ranges. A second map 90 defining BMEP ranges (bar) versus engine speed (rpm) identifying oil pressures required to the system bearings over the various engine operating ranges. A third map 92 defining BMEP ranges (bar) versus engine speed (rpm) identifies oil pressures required at the turbocharger over the various engine operating ranges. A fourth map 94 defining BMEP ranges (bar) versus engine speed (rpm) identifies oil pressures required at the pistons over the various engine operating ranges.

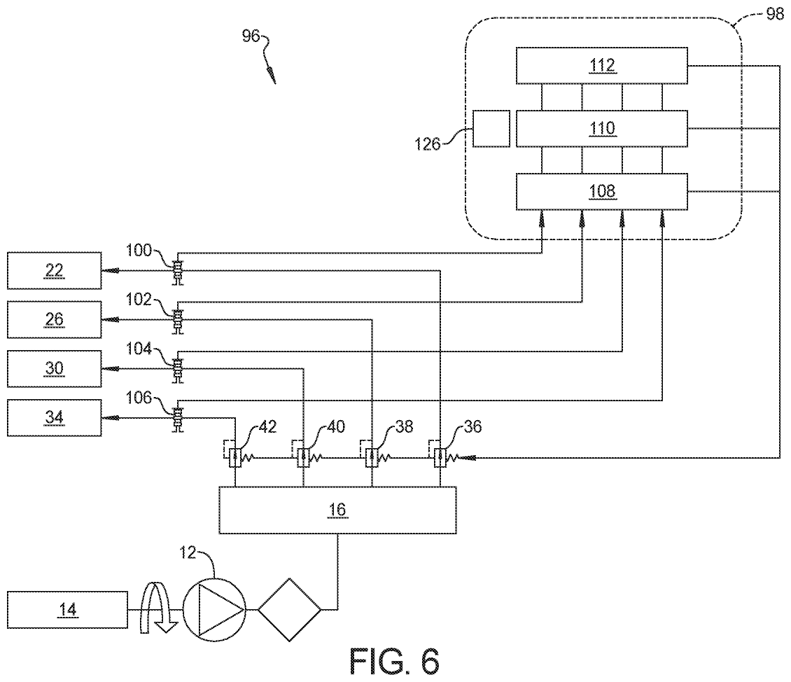

Referring to FIG. 6 and again to FIGS. 1 through 5, a pressure control system 96 for the split oil circuit 10 provides an electronic engine control module (ECM) 116 which generates individual control signals for each of the ECVs 36, 38, 40, 42 positioned in each branch. A first pressure sensor 100 provides a signal of a sensed pressure in the feed line to the turbocharger 22 which is fed to the ECM 98. A second pressure sensor 102 provides a signal of a sensed pressure in the feed line to the engine head 26 which is fed to the ECM 98. A third pressure sensor 104 provides a signal of a sensed pressure in the feed line to the bank of pistons 30 which is fed to the ECM 98. A fourth pressure sensor 106 provides a signal of a sensed pressure in the feed line to the multiple bearings 34 which is fed to the ECM 98. The output signals from each of the first pressure sensor 100, the second pressure sensor 102, the third pressure sensor 104 and the fourth pressure sensor 106 are received by a signal conditioning circuit 108 of the ECM 98.

An output from the signal conditioning circuit 108 is processed using a software circuit 110 which identifies from data tables saved in a memory of the ECM 98 the appropriate flow rate and pressure to each oil control device including the turbocharger 22, the engine head 26, the bank of pistons 30 and the multiple bearings 34 for each system operating point. An output from the software circuit 110 is fed to a pulse width modulated (PWM) driver 112, from which individual control signals are forwarded to each of the ECVs 36, 38, 40, 42.

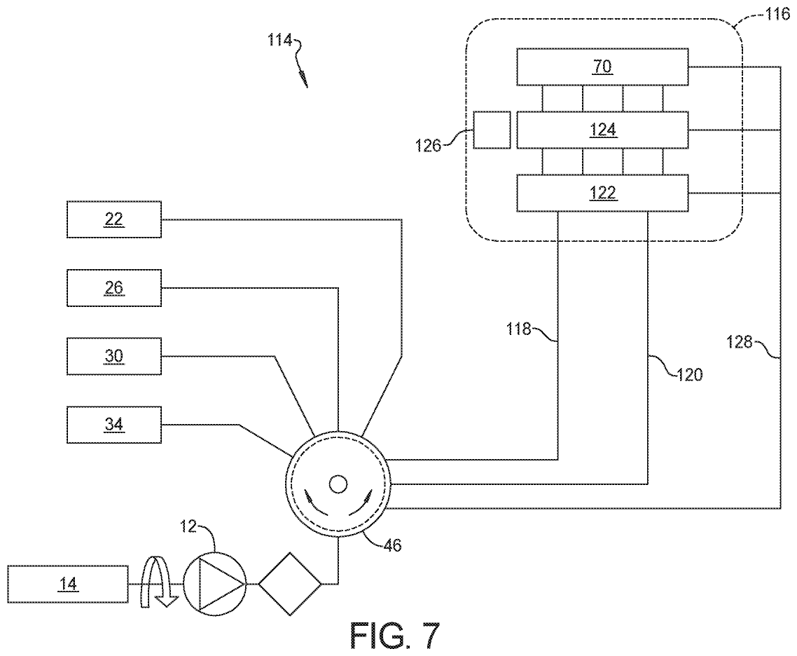

Referring to FIG. 7 and again to FIGS. 1 through 6, a pressure control system 114 is modified from the pressure control system 96 and generates control signals for the second split oil circuit 44 which control operation of the rotary valve 46. The second split oil circuit 44 provides an electronic engine control module (ECM) 116 which includes a signal conditioning circuit 122. The signal conditioning circuit 122 receives a rotary valve position signal 118 and an oil pressure signal 120 from the rotary valve 46. An output from the signal conditioning circuit 122 is processed using a software circuit 124 which identifies from data tables saved in a memory 126 of the ECM 116 the appropriate flow rate and target pressure required for each branch or supply line feeding the turbocharger 22, the engine head 26, the bank of pistons 30 and the multiple bearings 34 for each system operating point.

As discussed in reference to FIG. 3, the turbocharger target pressure 60, the piston target pressure 62, the main gallery target pressure 64 and the cylinder head target pressure 66 are determined in the ECM 116. Each of the target pressures are entered into the rotary valve position optimizer 68. The rotary valve position optimizer 68 may be incorporated in the software circuit 124 and satisfies the different pressure requests by identifying an optimized position of the rotary valve 46 which most closely satisfies all of the target pressure requests of the turbocharger target pressure 60, the piston target pressure 62, the main gallery target pressure 64 and the cylinder head target pressure 66 for a given system condition. The optimized rotary valve position identified by the rotary valve position optimizer 68 is forwarded to the rotary valve low level controller or pulse width modulated (PWM) driver 70 which generates and forwards a position change signal 128 to the rotary valve 46.

Engine working conditions (speed, load, temperature . . . ) are used as an input to define target oil pressure for each of the circuit branches (Turbocharger, Pistons, Main Gallery, and Cylinder head). The calculated target pressures are used as an input to the rotary valve's position optimization. A flow model of the lubrication circuit is inserted to define the rotary valve position that best satisfies the desired pressure levels in each branch.

The present system introduces valves and sensors in various branches of an oil circuit to control oil pressure through an engine control unit (ECU) input on the basis of multiple maps, a quantity of which is based on a quantity of the branches. The present system allows individual regulation of the oil pressure and oil flow rate in the various circuits using a flexible system. The present circuits provide for an overall reduction of the oil flow, while maintaining a constant pressure rise of the oil pump 12. This translates to a reduction of the torque adsorbed by the oil pump 12 which ranges between approximately 20% up to approximately 40% depending on the engine operating point. This also translates to a CO2 advantage of approximately 0.5%.

A system and method for controlling oil pressure and flow in an automobile vehicle oil system of the present disclosure offers several advantages. These include providing control of all the branches of an oil circuit which allows realizing an ideal circuit from a power consumption stand-point. Oil circuit branches which are controlled separately from each other based on the oil pressure reduce oil pump work and improve fuel economy.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A system for controlling oil pressure and flow in an automobile vehicle oil system, comprising:
an oil pump generating pressurized oil;
multiple oil system segments each having a feed line;
at least one flow control member in communication with the multiple oil system segments; and
a signal generating control device in communication with the at least one flow control member, the signal generating control device identifying one of multiple operating points of a vehicle engine, selecting a pressure and a flow rate of the pressurized oil for the feed line of each of the oil system segments optimizing the pressure and the flow rate of the pressurized oil at the identified one of the operating points and adjusting a position of the at least one flow control member to deliver the optimized pressure and the flow rate of the pressurized oil.

2. The system for controlling oil pressure and flow in an automobile vehicle oil system of claim 1, wherein the at least one flow control member defines a rotary valve.

3. The system for controlling oil pressure and flow in an automobile vehicle oil system of claim 2, wherein the rotary valve is directly connected to the feed line of each of the oil system segments.

4. The system for controlling oil pressure and flow in an automobile vehicle oil system of claim 1, wherein the oil system segments include a turbocharger, an engine head, a bank of pistons and multiple bearings.

5. The system for controlling oil pressure and flow in an automobile vehicle oil system of claim 4, wherein the feed line for each of the components includes:
a turbocharger feed line which provides oil flow to the turbocharger;
a head feed line providing oil flow to the engine head;
a piston feed line providing oil flow to the bank of pistons; and
a bearing feed line providing oil flow to the multiple bearings.

6. The system for controlling oil pressure and flow in an automobile vehicle oil system of claim 5, further including:
a signal conditioning circuit receiving a rotary valve position signal and an oil pressure signal from the rotary valve;
wherein an output from the signal conditioning circuit is processed using a software circuit which identifies from data tables saved in a memory an appropriate flow rate and a target pressure required for each feed line feeding the turbocharger, the engine head, the bank of pistons and the multiple bearings for each system operating point.

7. The system for controlling oil pressure and flow in an automobile vehicle oil system of claim 1, wherein the at least one flow control member defines multiple electronically-controlled valves (ECVs) individually positioned in the feed line of each of the segments to provide individualized pressure and flow rate control for each feed line.

8. The system for controlling oil pressure and flow in an automobile vehicle oil system of claim 7, wherein the oil system segments include a turbocharger having a turbocharger feed line, an engine head having an engine head feed line, a bank of pistons having a piston feed line and multiple bearings having a bearing feed line.

9. The system for controlling oil pressure and flow in an automobile vehicle oil system of claim 8, further including a pressure control system generating individual control signals for each of the ECVs positioned in each of the feed lines.

10. The system for controlling oil pressure and flow in an automobile vehicle oil system of claim 9, wherein the pressure control system is in communication with:
a first pressure sensor providing a signal of a sensed pressure in the turbocharger feed line;
a second pressure sensor providing a signal of a sensed pressure in the head feed line;
a third pressure sensor providing a signal of a sensed pressure in the piston feed line; and
a fourth pressure sensor providing a signal of a sensed pressure in the feed line to the bearing feed line;
wherein a first pressure and flow rate is delivered to the turbocharger, a second pressure and flow rate is delivered to the engine head, a third pressure and flow rate is delivered to the bank of pistons and a fourth pressure and flow rate is delivered to the bearings at each operating point of the system.

11. A system for controlling oil pressure and flow in an automobile vehicle oil system, comprising:
an oil pump generating pressurized oil for an engine;
multiple oil system segments each having a feed line;
at least one flow control member;
a signal generating control device in communication with the at least one flow control member, the signal generating control device identifying one of multiple operating points of a vehicle engine, selecting a pressure and a flow rate of the pressurized oil for the feed line of each of the oil system segments optimizing the pressure and the flow rate of the pressurized oil at the identified one of the operating points and adjusting a position of the at least one flow control member to deliver the optimized pressure and the flow rate of the pressurized oil; and
a control system in communication with the signal generating control device for directing operation of the flow control member, the control system collecting data defining engine working conditions.

12. The system for controlling oil pressure and flow in an automobile vehicle oil system of claim 11, wherein:
the flow control member defines a rotary valve in direct communication with each the multiple oil system segments; and
the control system from the engine working conditions enters different system maps saved in a memory to determine each of a turbocharger target pressure, a piston target pressure, a main gallery target pressure, and a cylinder head target pressure.

13. The system for controlling oil pressure and flow in an automobile vehicle oil system of claim 12, wherein each of the target pressures are entered into a rotary valve position optimizer, the rotary valve position optimizer identifying an optimized rotary valve position which most closely satisfies all of the turbocharger target pressure, the piston target pressure, the main gallery target pressure and the cylinder head target pressure for a given system condition.

14. The system for controlling oil pressure and flow in an automobile vehicle oil system of claim 13, further including a rotary valve controller, wherein the optimized rotary valve position identified by the rotary valve position optimizer is forwarded to the rotary valve controller which signals position changes to the rotary valve.

15. The system for controlling oil pressure and flow in an automobile vehicle oil system of claim 11, wherein the at least one flow control member defines multiple electronically-controlled valves (ECVs) individually positioned in the feed line of each of the segments to provide individualized pressure and flow rate control for each feed line.

16. The system for controlling oil pressure and flow in an automobile vehicle oil system of claim 11, further including a pressure sensor positioned in each of the feed lines, each producing a pressure signal forwarded to a signal conditioning circuit of the control system.

17. The system for controlling oil pressure and flow in an automobile vehicle oil system of claim 11, further including:
a common distribution rail receiving pressurized oil from the oil pump; and
each feed line of the multiple oil system segments receiving oil flow from the common distribution rail.

18. A method for controlling oil pressure and flow in an automobile vehicle oil system, comprising:
generating pressurized oil for an engine using an oil pump;
connecting an individual feed line to each of multiple oil system segments;
providing at least one flow control member;
positioning a signal generating control device in communication with the at least one flow control member, the signal generating control device:
identifying one of multiple operating points of a vehicle engine;
selecting a pressure and a flow rate of the pressurized oil for the feed line of each of the oil system segments; and
optimizing the pressure and the flow rate of the pressurized oil at the identified one of the operating points; and
adjusting a position of the at least one flow control member to deliver the optimized pressure and the flow rate of the pressurized oil using a control system in communication with the signal generating control device.

19. The method for controlling oil pressure and flow in an automobile vehicle oil system of claim 18, further including collecting data defining engine working conditions and entering the data into the control system.

20. The method for controlling oil pressure and flow in an automobile vehicle oil system of claim 18, wherein the adjusting a position of the at least one flow control member defines rotating a rotary valve based on a signal generated by the control system and delivered to the rotary valve by the signal generating control device.
